(19) United States
(12) Patent Application Publication
(10) Pub. No.: US 2026/0162908 A1
(43) Pub. Date: Jun. 11, 2026

(54) ELECTRODE OF DYE-SENSITIZED SOLAR CELL AND METHOD FOR MANUFACTURING THE SAME

(71) Applicant: SOOKMYUNG WOMEN'S UNIVERSITY INDUSTRY-ACADEMIC COOPERATION FOUNDATION, Seoul (KR)

(72) Inventors: Young Soo JOUNG, Seoul (KR); Jee Yoon KIM, Seoul (KR); YeJin KANG, Seoul (KR)

(21) Appl. No.: 18/708,088

(22) PCT Filed: Sep. 19, 2022
(86) PCT No.: PCT/KR2022/013941

§ 371 Date: May 7, 2024

(30) Foreign Application Priority Data
Jan. 18, 2022 (KR) 10-2022-0007186

(51) Int. Cl. H01G 9/20

(52) U.S. Cl. CPC H01G 9/2027; H01G 9/2022

(57) ABSTRACT

Disclosed is a method for manufacturing an electrode for a dye-sensitized solar cell, the

method comprising: (a) forming a precursor layer on a conductive substrate using a first suspension in which TTIP (Titanium Tetra-IsoPropoxide) is dispersed; and (b) forming a metal oxide layer on the precursor layer using electrophoretic deposition, wherein the (b) includes: preparing a second suspension in which titanium dioxide (TiO₂) is dispersed; and immersing a first electrode as the conductive substrate and a second electrode as a counter electrode to the first electrode into the second suspension, and applying power to the first and second electrodes, wherein the second suspension contains a polyethylenimine (PEI) solution to increase electrical conductivity via a mutual reaction between the titanium dioxide (TiO₂) and the precursor layer. Therefore, a highly efficient electrode may be manufactured in a low temperature process of 100° C. or lower via a combination of the precursor layer and the PEI.

### TECHNICAL FIELD

The present disclosure relates to an electrode of a dye-sensitized solar cell and a manufacturing method thereof, and more specifically, to an electrode of a dye-sensitized solar cell that may be manufactured in a low-temperature process and a manufacturing method thereof.

### BACKGROUND ART

Recently, interest in alternative energy sources that may replace existing fossil fuels is rapidly increasing. Among them, solar cells using solar energy are in the spotlight because, unlike other energy sources (such as nuclear energy), the solar energy is infinite and environmentally friendly.

Recently, silicon solar cells have been in the spotlight since the development of Se solar cells in 1983. However, silicon solar cells are very expensive to manufacture, making them difficult to put into practical use. To overcome this problem, research and development is being actively conducted on inexpensive dye-sensitized solar cells.

Unlike the silicon solar cells, the dye-sensitized solar cel is a photoelectrochemical solar cell mainly composed of photosensitive dye molecules that may absorb visible light and generate electron-hole pairs, and a transition metal oxide that transfers the generated electrons. A representative example of the dye-sensitized solar cell known so far is one published by Gratzel et al. in Switzerland.

FIG. 1 is a diagram showing a structure of a conventional dye-sensitized solar cell.

As shown in FIG. 1, a conventional dye-sensitized solar cell 1 includes a working electrode 10, a counter electrode 20 disposed opposite to the working electrode 10, and an electrolyte 30 interposed between the working electrode 10 and the counter electrode 20. A light absorption layer 13 may be disposed on one surface of the working electrode 10, and the light absorption layer 13 may be generally made of a metal oxide 11 such as titanium dioxide (TiO₂) having an adsorbed dye 12 such as cadmium sulfide (CdS) therein.

The dye 12 may exhibit neutral (S), transition state (S*), and ionic state (S+), respectively. When sunlight is absorbed by the dye, the dye molecule undergoes an electronic transition from the ground state (S/S+) to the excited state (S*/S+), thus forming an electron-hole pair. Electrons in an excited state move to the conduction band (CB) of the metal oxide and then diffuse to the working electrode 10, and the electrons that have reached the working electrode 10 pass through an external circuit to the counter electrode 20. In this way, an electromotive force may be generated.

The dye that has lost its electrons by the metal oxide may be reduced by obtaining electrons from the electrolyte 30. In the electrolyte 30, for example, iodide ions are oxidized to iodine to supplement the electrons into the dye, and then, iodine receives electrons that reach the counter electrode 20 and may be reduced back to iodide.

The solar cell operates by repeating the above-described redox process.

The dye-sensitized solar cell as described above is eco-friendly and flexible, has a lower manufacturing cost per power compared to existing silicon cells, and may provide color and ensure transparency at the same time. Thus, the dye-sensitized solar cell may replace the existing solar cells and thus has received attention.

However, conventionally, in order to deposit the metal oxide 11 such as the titanium dioxide (TiO₂) on the electrode 10, titanium dioxide (TiO₂) in a form of a paste is spin-coated. Thus, it may be difficult to control a thickness of the metal oxide layer precisely. A high temperature heat treatment process (or sintering process) of 400 to 500° C. or higher is essential. Thus, there is a problem in that a selection of a material of the electrode 10 is limited. That is, there is a problem that a transparent plastic substrate such as ITO-PEN, which may be deformed by high heat cannot be used as the material of the electrode 10.

Accordingly, there is a need to present necessary technologies to solve these problems.

### DISCLOSURE

### Technical Purpose

A purpose of the present disclosure is to provide an electrode for a dye-sensitized solar cell that may be manufactured via a non-sintering process and in which a thickness of the metal oxide layer may be precisely controlled, and a manufacturing method thereof.

### Technical Solution

In order to achieve the purpose, there is provided a method for manufacturing an electrode for a dye-sensitized solar cell, the method comprising: (a) forming a precursor layer on a conductive substrate using a first suspension in which TTIP (Titanium Tetra-IsoPropoxide) is dispersed; and (b) forming a metal oxide layer on the precursor layer using electrophoretic deposition, wherein the (b) includes: preparing a second suspension in which titanium dioxide (TiO₂) is dispersed; and immersing a first electrode as the conductive substrate and a second electrode as a counter electrode to the first electrode into the second suspension, and applying power to the first and second electrodes, wherein the second suspension contains a polyethylenimine (PEI) solution to increase electrical conductivity via a mutual reaction between the titanium dioxide (TiO₂) and the precursor layer.

In one embodiment, the (a) include applying the first suspension on the conductive substrate in a spin coating scheme.

In one embodiment, the conductive substrate is a conductive glass or plastic substrate, wherein a combination of the (a) and the (b) is a non-sintering process.

In one embodiment, the (b) is repeated at least once, wherein a thickness of the metal oxide layer is adjusted according to an application voltage of the power and an application time of the power.

In one embodiment, the method further comprises (c) performing heat treatment for 30 minutes to 4 hours at a temperature of 100° C. or lower.

In order to achieve the purpose, there is provided an electrode for a dye-sensitized solar cell, the electrode comprising: a conductive substrate; a precursor layer formed on the conductive substrate using a first suspension in which TTIP (Titanium Tetra-IsoPropoxide) is dispersed; and a metal oxide layer formed on the precursor layer using electrophoretic deposition, wherein the electrophoretic deposition is performed by immersing a first electrode as the conductive substrate and a second electrode as a counter electrode to the first electrode into a second suspension in which titanium dioxide (TiO₂) is dispersed, and applying power to the first and second electrodes, wherein the second suspension contains a polyethylenimine (PEI) solution to increase electrical conductivity via a mutual reaction between the titanium dioxide (TiO₂) and the precursor layer.

In order to achieve the purpose, there is provided a dye-sensitized solar cell comprising: a working electrode as the electrode as described above; a counter electrode spaced from and facing the working electrode; an electrolyte interposed between the working electrode and the counter electrode; and a light absorption layer interposed between the working electrode and the electrolyte and including a metal oxide to which a dye has been adsorbed.

### Advantageous Effects

According to the present disclosure, the electrodes for the dye-sensitized solar cell may be manufactured through a non-sintering process below 100° C. Thus, not only may the electrode made of plastic be easily manufactured, but also the electrode with improved efficiency may be manufactured.

Furthermore, because the metal oxide layer is formed using electrophoresis (EPD), the thickness of the metal oxide layer may be precisely controlled.

### DESCRIPTION OF DRAWINGS

FIG. 1 is a diagram showing a structure of a conventional dye-sensitized solar cell.

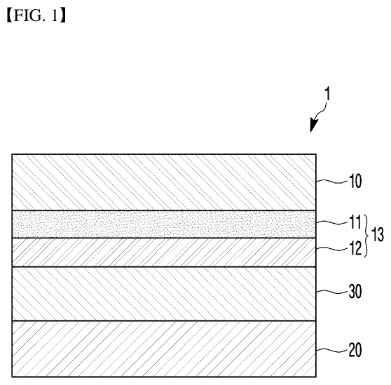

FIG. 2 is a step-by-step flowchart of a manufacturing method of an electrode for a dye-sensitized solar cell according to one embodiment of the present disclosure.

FIG. 3 is a photograph showing a surface of a metal oxide layer produced according to one embodiment of the present disclosure.

FIG. 4 is a diagram showing XRD analysis results of an electrode manufactured according to one embodiment of the present disclosure.

FIG. 5 is a graph showing the efficiency of an electrode manufactured according to one embodiment of the present disclosure.

### BEST MODE

The present disclosure will be described in detail below through preferred embodiments. Prior to this description, the terms and words used herein and claims should not be construed as limited to their usual or dictionary meanings. Rather, based on the principle that an inventor may appropriately define the concept of the term in order to describe his or her invention in the best way, the terms and words used herein and claims should be interpreted as meaning and concept consistent with the technical idea of the present disclosure. Therefore, a configuration of the embodiment as described in the present disclosure is only one of the most desirable embodiments of the present disclosure and does not represent all of the technical ideas of the present disclosure. It should be understood that at the time of filing the present application, there may be various equivalents and modifications that may replace the embodiments. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof.

### Manufacturing Method of Electrode for Dye-Sensitized Solar Cell

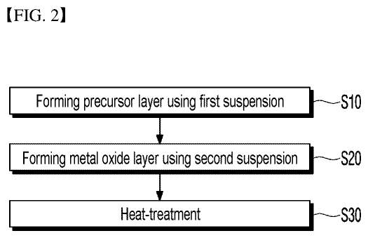

FIG. 2 is a step-by-step flowchart of a manufacturing method of an electrode for a dye-sensitized solar cell according to one embodiment of the present disclosure.

As shown in FIG. 2, the method for manufacturing the electrode for the dye-sensitized solar cell according to one embodiment of the present disclosure may include forming a precursor layer using a first suspension on a conductive substrate in S10, and forming a metal oxide layer on the precursor layer formed on the conductive substrate in S20.

In other words, the electrode for the dye-sensitized solar cell according to the present disclosure may be manufactured by sequentially stacking the precursor layer and the metal oxide layer on the conductive substrate.

The conductive substrate is an object on which the precursor layer is deposited. Any conductive material may be applied for the electrode of the dye-sensitized solar cell, specifically, the working electrode. The material may be a metal material as well as a conductive material coated on a non-conductive substrate (e.g., synthetic resin material or glass material, etc.). However, the present disclosure does not specifically limit the material.

A first suspension in which TTIP (Titanium Tetra-IsoPropoxide) is dispersed may be applied to the conductive substrate.

At this time, the application scheme may include screen printing, doctor blade, brush, spin coating, etc. The first suspension may be applied to the conductive substrate in the spin coating manner according to a preferred embodiment of the present disclosure.

The precursor layer formed by applying the first suspension to the conductive substrate may be interposed between the surface of the conductive substrate and the metal oxide layer as described later, and may strengthen the bonding force between the conductive substrate and the metal oxide layer.

The first suspension according to one embodiment of the present disclosure is a suspension in which TTIP (Titanium Tetra-IsoPropoxide) is dispersed, and may be prepared by dispersing TTIP in a mixed solution of acetylacetone and isopropyl alcohol.

The mixed solution according to one embodiment of the present disclosure may be prepared by mixing acetylacetone and isopropyl alcohol with each other in a volume ratio of 1:3 to 1:5, preferably 1:4. A content of the TTIP added to the mixed solution of acetylacetone and isopropyl alcohol is not particularly limited, but is preferably in a range of 0.3 to 0.5M, preferably 0.35M.

The first suspension prepared in this way may be dropped on the conductive substrate, and the first suspension may be spread on the conductive substrate using a spin coater. In this regard, an amount of the first suspension dropped on the conductive substrate and a rotation speed or a rotation time of the spin coater may be determined to vary depending on an area size of the conductive substrate.

In a specific example, 10 to 20 μl, preferably 20 μl of the first suspension may be dropped on a 2×4 cm² substrate and may be spread three times, each time for 30 seconds, at 2000 rpm to apply the first suspension on the conductive substrate.

Thereafter, the metal oxide layer may be deposited on the conductive substrate on which the precursor layer has been formed using a second suspension in S20.

According to one embodiment of the present disclosure, electrophoretic deposition (EPD) may be used to form the metal oxide layer on the precursor layer.

That is, the metal oxide layer may be deposited on the precursor layer in an electrophoresis manner using the second suspension as an electrolyte. In this regard, the quality of the deposition is affected by the electrolyte in which fine particles are dispersed.

Therefore, according to one embodiment of the present disclosure, the electrolyte used when forming the metal oxide layer is preferably a polar solvent commonly used when using electrophoresis. Specifically, the electrolyte used when forming the metal oxide layer may be ethanol when dispersing TiO₂ particles.

A content of the TiO₂ particles added to ethanol is not particularly limited, and may be in a range of preferably 0.04 to 0.06M, preferably 0.05M, and a weight ratio of TTIP and TiO₂ may be in a range of 0.5:1 to 2:1, preferably 1:1.

The second suspension prepared in this way may be used as an electrolyte. The conductive substrate on which the precursor layer has been formed may be used as a first electrode, and a second electrode may be used as a counter electrode. Direct current power may be applied to the first and second electrodes immersed in the electrolyte.

In this regard, the first and second electrodes immersed in the electrolyte may be arranged to face each other and to be spaced from each other by at a predetermined distance. In a specific example, the first electrode may be used as an anode, and the direct current power may be applied thereto for 3 to 4 minutes such that the electric field strength of the electric field generated between the first and second electrodes may be in a range of 1 to 5 V/cm, preferably, 3V/cm.

In this regard, a thickness of the metal oxide layer deposited may be controlled by adjusting the application power and/or an application time of the electric field generated therebetween via the application of the power to the first and second electrodes.

Furthermore, the deposition rate may be adjusted by adjusting the strength of the electric field generated therebetween via the application of the power to the first and second electrodes. Increasing the strength of the electric field may allow the deposition rate to be increased.

However, when depositing the metal oxide layer, it is desirable that the intensity of the electric field or the size of the electrode be constant.

According to one embodiment of the present disclosure, an additive may be added to the electrolyte, and preferably, the additive is a polyethylenimine (PEI) solution. This is because the PEI solution stabilizes the TiO₂ suspension and acts as a conductive polymer to strengthen the bonding force between the precursor layer and the TiO₂ particle layer generated by electrophoresis, thereby improving electrical conductivity.

A content of the PEI added to ethanol is not particularly limited, but is preferably in a range of 10 to 15 g/L, preferably 12 g/L. In an example, the electrolyte may be prepared by dispersing 12 g/L of PEI particles and 4 g/L of TiO₂ particles in ethanol.

At this time, the immersion time of the conductive substrate in the electrolyte as the mixture of PEI and TiO₂ to form the metal oxide layer is not particularly limited. In one example, the intensity of the electric field is preferably in a range of 3 to 5 V/cm. Specifically, a direct current voltage of 3 V may be applied to the electrodes spaced by 1 cm apart from each other to generates the electric field of 3 V/cm, and the immersion duration may be preferably in a range of 1 to 3 minutes.

According to one embodiment of the present disclosure, a low-temperature heat treatment step in S30 may be further included in the method.

When using a conventional TTIP mixture as the precursor layer, it is common to heat treat at a high temperature of 350° C. to 500° C. for the synthesis reaction. However, the heat treatment step in S30 according to one embodiment of the present disclosure may be performed at a low temperature of 100° C. or lower.

Specifically, the low-temperature heat treatment step in S30 according to one embodiment of the present disclosure may include heating the conductive substrate on which the precursor layer and the metal oxide layer have been formed for 30 minutes to 4 hours at a temperature of 100° C. or lower, preferably for 1 hour at 40° C. to 60° C., more preferably at 50° C.

That is, according to one embodiment of the present disclosure, even when the TTIP mixture is used as the precursor layer, a highly efficient electrode may be manufactured in a low temperature process of 100° C. or lower using a combination of the TTIP mixture and PEI.

Since the electrode for the dye-sensitized solar cell may be manufactured in this low-temperature process, the conductive substrate may be made of synthetic resin or glass rather than metal.

Hereinafter, the present disclosure will be described in more detail based on examples of the present disclosure, but the scope of the present disclosure is not limited by the examples presented below.

### EXAMPLE 1

The first suspension was prepared by mixing and stirring 2 mL of acetylacetone, 8 mL of isopropyl alcohol, and 1 g of titanium isopropoxide (TTIP) with each other and 20 [symbol] of the first suspension was applied on a 2×4 cm² conductive transparent plastic substrate (ITO-PEN). Using a spin coater, the first suspension was spread three times at 2000rpm, each time for 30 seconds.

Afterwards, the electrolyte was prepared by mixing 250 mL of ethanol, 3 g of PEI, and 1 g of TiO₂ with each other, and the above conductive substrate as the first electrode and a second electrode as the counter electrode thereto spaced from each other by 1 cm were immersed in the electrolyte. Then, 3 V was applied thereto for 3 minutes, and the heat treatment was performed at 50° C. for 1 hour. Thus, the working electrode was prepared.

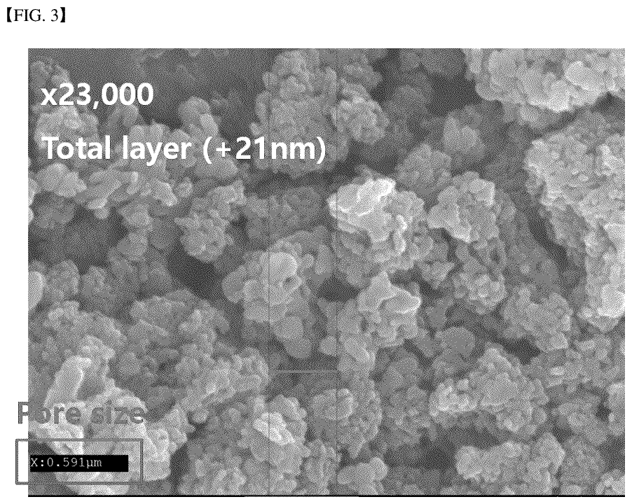

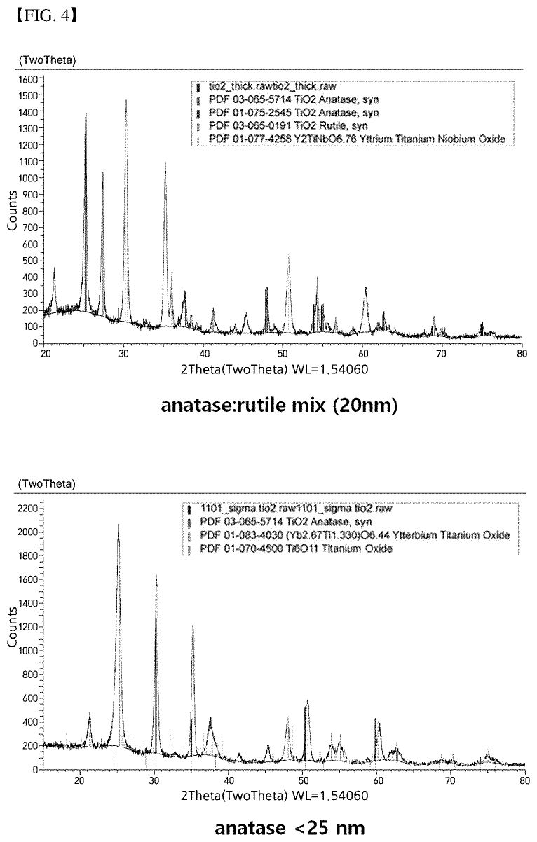

The SEM image of the surface of the working electrode as prepared is shown in FIG. 3, and as a result, based on the XRD analysis, it was identified that the conductive substrate, the precursor layer, and the metal oxide layer were sequentially stacked (see FIG. 4).

### Comparative Example 1

The electrode for the dye-sensitized solar cell was manufactured in the same manner as in Example 1, except that the precursor layer was absent and the metal oxide layer including PEI was directly formed on the conductive substrate, and then was subjected to heat treatment.

### Comparative Example 2

The electrode for the dye-sensitized solar cell was manufactured in the same manner as in Example 1, except that the metal oxide layer free of the PEI was formed on the precursor layer and then was subjected to heat treatment.

### Experimental Example 1

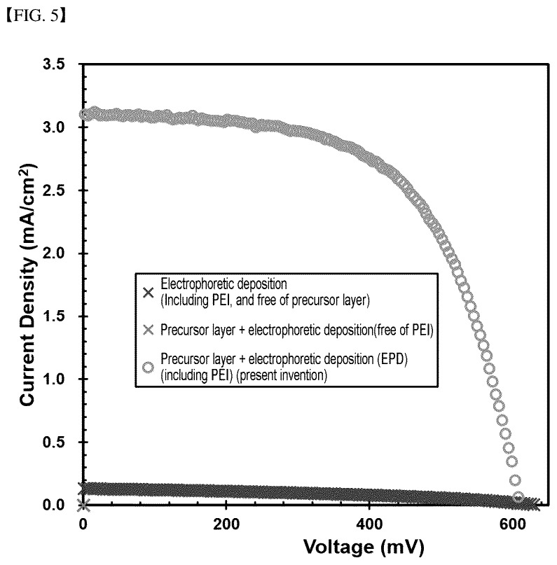

When the dye-sensitized solar cell was manufactured using the electrode manufactured according to Example 1 above and the electrode efficiency was measured based on a light intensity of 800 W/m². As shown in FIG. 5, FF (Fill Factor) was in a range of 0.59 to 0.61, and η (efficiency) was 1.4% (green line).

Furthermore, the electrode efficiencies according to Comparative Examples 1 and 2 are shown in blue and red in FIG. 5, respectively. η was in a range of 0.01 to 0.1%, and in particular, the efficiency (η) according to Comparative Example 2 could not be measured.

### Manufacturing Method of Dye-sensitized Solar Cell

The electrode for the dye-sensitized solar cell manufactured according to one embodiment of the present disclosure is used as the working electrode 10. The counter electrode 20 thereto is prepared. The electrolyte of the dye-sensitized solar cell are interposed between both electrodes. The working electrode 10 and the counter electrode 20 were pressed against each other such that the dye-sensitized solar cell 1 may be manufactured.

In this regard, the working electrode 10 may include a substrate and a conductive material (for example, TiO2, CNT, etc.) coated thereon. The light absorption layer 13 may be disposed on the working electrode 10 and may include a metal oxide layer 11 coated on one surface of the working electrode 10 and the dye 12 (for example, N-719, etc.) adsorbed on the metal oxide layer.

The preferred embodiment of the present disclosure has been described above in detail with reference to the drawings. The description of the present disclosure is for illustrative purposes. A person with ordinary knowledge in the technical field to which the present disclosure belongs may understand that the present disclosure may be easily modified into another specific form without changing the technical idea or essential features of the present disclosure.

Therefore, the scope of the present disclosure is indicated by the patent claims described later rather than the detailed description above, and all changes or modified forms derived from the meaning, scope, and equivalent concept of the claims should be interpreted as being included in the scope of the present disclosure.

1. A method for manufacturing an electrode for a dye-sensitized solar cell, the method comprising:
(a) forming a precursor layer on a conductive substrate using a first suspension in which TTIP (Titanium Tetra-IsoPropoxide) is dispersed; and
(b) forming a metal oxide layer on the precursor layer using electrophoretic deposition,
wherein the (b) includes:
preparing a second suspension in which titanium dioxide (TiO₂) is dispersed; and
immersing a first electrode as the conductive substrate and a second electrode as a counter electrode to the first electrode into the second suspension, and applying power to the first and second electrodes,
wherein the second suspension contains a polyethylenimine (PEI) solution to increase electrical conductivity via a mutual reaction between the titanium dioxide (TiO₂) and the precursor layer.

2. The method of claim 1, wherein the (a) include applying the first suspension on the conductive substrate in a spin coating scheme.

3. The method of claim 1, wherein the conductive substrate is a conductive glass or plastic substrate,
wherein a combination of the (a) and the (b) is a non-sintering process.

4. The method of claim 1, wherein the (b) is repeated at least once,
wherein a thickness of the metal oxide layer is adjusted according to an application voltage of the power and an application time of the power.

5. The method of claim 1, wherein the method further comprises (c) performing heat treatment for 30 minutes to 4 hours at a temperature of 100° C. or lower.

6. An electrode for a dye-sensitized solar cell, the electrode comprising:
a conductive substrate;
a precursor layer formed on the conductive substrate using a first suspension in which TTIP (Titanium Tetra-IsoPropoxide) is dispersed; and
a metal oxide layer formed on the precursor layer using electrophoretic deposition,
wherein the electrophoretic deposition is performed by immersing a first electrode as the conductive substrate and a second electrode as a counter electrode to the first electrode into a second suspension in which titanium dioxide (TiO₂) is dispersed, and applying power to the first and second electrodes,
wherein the second suspension contains a polyethylenimine (PEI) solution to increase electrical conductivity via a mutual reaction between the titanium dioxide (TiO₂) and the precursor layer.

7. A dye-sensitized solar cell comprising:
a working electrode as the electrode of claim 6;
a counter electrode spaced from and facing the working electrode;
an electrolyte interposed between the working electrode and the counter electrode; and
a light absorption layer interposed between the working electrode and the electrolyte and including a metal oxide to which a dye has been adsorbed.
